(19) United States
(12) Patent Application Publication
(10) Pub. No.: US 2004/0032831 A1
(43) Pub. Date: Feb. 19, 2004

(54) Simplest shortest path first for provisioning optical circuits in dense mesh network configurations

(76) Inventor: Wallace Matthews, Mendon, MA (US)

Correspondence Address: Wallace Matthews, 41 Kinsley Lane, Mendon, MA, 01756, US

(21) Appl. No.: 09/981,278

(22) Filed: Aug. 14, 2002

(51) Int. Cl. H04L 12/26; H04L 12/28

(52) U.S. Cl. 370/238; 370/252; 370/254

(57) ABSTRACT

A method for determining the shortest simplest path in an optical network with mixed DWDM transmission characteristics, mixed switching methodologies (i.e. micro mirrors, bubbles, Electronic TDM, Electronic cross bar, optical signal regeneration, and wavelength translation using optical devices). Disclosed in the invention is: a.) a multi-layered network path determination method that resolves over-constrained routing requirements, b.) an application of A that resolves routing constraints described for the optical networking environment, c.) A Dense Mesh simplification method that reduces the computation and processing power to find the best approximate path through the network, d.) A caching strategy to cache approximate paths, rather than exact paths, and to age out cache entries just before they become incorrect e.) A method of calculating multiple metrics and checking them against routing requirements during the path determination process rather than afterwards (as is done usually) f.) A method to turn an approximate path into an exact path that enforces simplest shortest path first and triggers cache age out, g.) A method of filling cache entries that enforces simplest shortest path first

The “Simplest path” has no signal regenerators, wavelength translators, or use of electronic switching. Slightly simpler paths require a minimum number of signal regenerators, wavelength translators, or electronic switching. In general terms it is a path that can be completed at the lowest level possible first and then progressively falls back to higher and higher levels to complete a path that meets routing requirements. “Simplest Shortest path” indicates that a longer path that is simpler has precedence over a “Shorter path” that has additional resource requirements.

### PRIOR ART

### DESCRIPTION

1. Field of the Invention

This invention relates to communications networks, and more particularly to automated path determination across multiple nodes and circuits in a network that are constrained by routing requirements and the characteristics or the transmission facilities and switching systems that make up the network. Networks as defined for this application are any interconnections of data transmission facilities and terminal equipment that is capable of joining multiple transmission segments into a transmission path that acts as integral communication circuit and maintains the integrity of the data that is transmitted via that path. The network thus defined is not limited to a specific type of modulation technology, communication methodology, or family of communications protocols. The invention may be embodied in an Operations Supervisory System, a provisioning Application, a soft switch application, a route srever, a switching control system, or embedded in the switching equipment itself.

Although the primary environment for the invention is data communications, it has applications to any mesh of nodes and links that transport something from a location to another location, where there are multiple links and/or nodes to transit to get from the source to the destination. Examples are networks for transporting natural gas, oil, and electricity. Highways and electronic circuit boards can be modeled as such networks.

2. Prior Art

Asynchronous Transfer Mode's PNNI routing methodology (within the public domain) provides hierarchal routing as does OSPF for IETF TCP/IP protocols (within the public domain). Both use a Shortest Path First method of selecting paths. Both uses are designed for scaling networks or portion's of networks into suitable sized pieces for an automated routing application to return routes in reasonable timeframes. In both cases, sub-sets of a network are summarized into a simulated node for the use of higher level routing levels. This invention does not claim exclusivity to multiple level networks. It does claim exclusivity to multiple levels where each level has distinct routing properties and that lower levels are summarized as links to the higher levels and that a switching node may appear in multiple levels of the network concurrently. Assigning levels to specific routing properties, allows the method to be useful for resolving over constrained routing requirements. OSPF stipulates the use of Djikstra's algorithm to find routes. PNNI doesn't require it but uses it in its reference implementation and all commercial versions known to the author use it. U.S. Pat. No. 5,999,517 illustrates the use of hierarchy for scaling and also in differentiation show the difference in the inventions use for resolving multiple constraints. U.S. Pat. No. 5,805,593 illustrates a non-Djikstra path determination method, that unfortunately is a well known maze runner method that has been in the public domain since first described in automata articles in the 1950s.

Djikstra's algorithm uses a single metric to determine a route and the way it deals with its candidate list (internal component of the algorithm) and terminates its search, it is incapable of using multiple metrics concurrently. The only known algorithm that uses multiple metrics concurrently that can be found in the patents libraries is U.S. Pat. No. 5,521,910. It does so while building a spanning tree as stated in its claim 1. U.S. Pat. No. 5,732,192 uses multiple metrics during path determination for analyzing the flow of power in an electrical power grid.

The invention doesn't claim exclusivity for the use of multiple metrics, it claims exclusivity to their use in multiple level networks where the inter-relations between levels is based upon the use of multiple metrics for each level and cross level routing decisions are based upon having the information from multiple levels already calculated and available. This avoids a lot of wasted processing in what ATM calls ‘crankback’ when one of the routing requirements has been violated while exploring a potential path. U.S. Pat. No. 5,317,562 illustrates the state of the art in metrics. It does a path determination on a single metric and then checks that the path meets the route requirements of remaining metrics. If the path fails another metric it is thrown away, the algorithm is biased to not repeat that path, and then it is run again to get another path to consider. This invention calculates all metrics in parallel and throws away any potential paths that fail the route requirements as they are encountered in the path search. Thus all paths returned automatically meet the route requirements. U.S. Pat. No. 5,893,081 illustrates the use of multiple metrics for evaluating paths in automobile routing systems.

Djikstra's algorithm behaves weakly in dense mesh topologies because it is based upon spanning trees that ignore many of the links in a dense mesh to eliminate the redundant paths that may cause loops in the algorithm. This in turn congests the paths that participate in the sparse spanning tree. The redundant paths and their potential for spreading congestion across themselves is the primary motivation for Dense Mesh deployment in networks.

There is much literature in the public domain that discusses routing in Dense Mesh networks. Most of it is in the area of Operations Research on how to break the problem down into subsets using summarization of regions of the network. None has been found that deals with topologies resulting from large numbers of links that share common termination points which is the primary impetus of Dense Mesh networks in fiber optic networks with large numbers of wavelengths (i.e. lambdas) per fiber and large numbers of fibers per cable bundle. This claim alone is a major contributor to the good performance of the method. The second best contributor is the heuristic called the pheromone aggregate that is borrowed from the behavior of intelligent autonomous agents that in turn borrowed it from insect behavior (Bees and Ants). U.S. Pat. No. 5,937,397 illustrates the use of heuristics roughly similar to how pheromone aggregates do so. U.S. Pat. No. 6,151,327 and U.S. Pat. No. 6,016,485 discusses summarization of the network to reduce route determination time.

U.S. Pat. No. 6,205,154 illustrates the state of the art in provisioning optical networks. It explains how to match tail paths at subsidiary rates to groups of open sub-channels in backbone links that already exist between a source and destination switching center. Circuit path determination in optical networks is typically a manual process.

U.S. Pat. No. 6,205,154 illustrates the state of the art in resource allocation in that each resource is allocated in isolation from the other resources needed to establish a circuit rather than in a coordinated way as the invention does.

U.S. Pat. No. 6,016,306 illustrates a weight metric that is similar to the minimum type metrics of the invention. They differ in that the minimum type considers all nodes and or links along a path rather than just key choke points.

Jargon

Lambda—Synonymous with Wavelength—It is a specific portion of the light spectra. From physics where the Greek letter lambda is uniformly used as the symbol for the frequency of a light.

MEM—Micro electronically controlled Mirrors—A new emerging technology for redirecting light

O-E-O—Optical to Electrical to Optical devices such as SONET switches

WDM—Wave Division Multiplexing where multiple light sources all using a different light wavelength (i.e. lambda) to achieve multiple data streams over single fiber.

### BACKGROUND OF THE INVENTION

Today we are seeing a paradigm shift in how data networks are constructed. Existing networks backbones composed of fiber optic media for data transport, SONET framing, and electronic switching. Fibers carry a single data stream at data rates of 2.5 Gigabits per second and the aggregate switching capacity in switching centers is in the order of magnitude of 100-200 Gigabits. Fiber Optic signals need to be regenerated every 5-10 kilometers with expensive regeneration equipment that converts the optical signals to electronic signals that regenerate the digital signal and then amplify the signal for retransmission. End to end circuits are planned, engineered, and installed by highly trained personnel using manual methods and exotic test equipment in the switching centers.

Overlay telephone and data networks that utilize the backbone optical network use adaptive routing technologies such as ATM's PNNI, TCP/IP's OSPF with the switches making dynamic switching with no manual intervention. Intermediate SONET networks use static engineered rings with manual provisioning and automated failover or recovery switching.

Optical pumping and newer fiber optics technology has extended the data regeneration distances to 50 or more kilometers. Transmission equipment using Dense Wave Division Multiplexing are transmitting 128 or more data streams per fiber at data rates of 10 Gigabits and with laboratory systems doing 256 or more data streams per fiber at data rates of 40 or 80 Gigabits. The aggregate data rates traversing switching centers are now 1000s of terabits far exceeding the aggregate switching capacity of the electronic switching equipment. New switching technology using micro-mirrors or bubbles support switching optical data streams without optical conversion. They are capable of having their switching remotely controlled However, they inject additional signal degradation without providing signal regeneration. Discrete signal regenerators using tunable VCSEL laser transmitters are working in the lab and can provide signal regeneration and translation between wavelength (lambda) configurations. These units are expensive and will only be used where they are required to by the end to end data circuits.

Switching centers are already seeing a diversity of DWDM configurations and switching technologies, each presenting their own constraints to routing.

Constraints are:

1.) When insertion losses aggregate from fiber and or switch traversals reach threshold values, signal regenerators need to be installed or switched into the path.

2.) When DWDM configurations of one fiber don't match those of the next fiber to be transited along a data path, wavelength (i.e. lambda) translators must be installed or switched into the data path.

3.) Mirrors preserve wavelengths from end to end, so paths that use Lambda switching as their only switching medium need to have the same wavelength assigned to a path from end to end. This introduces the constraint that to create a multi-hop path we need to know which wavelengths are available for assignment for all fibers that participate in the path so that we can choose one that is available for all fibers. There is a possibility of lambda (i.e. wavelength) assignment blocking. So if this is not done as part of path determination, we can wind up in a situation of endless crankback.

4.) When a wavelength must have a lower data rate signal added or dropped for delivery along a secondary path, this requires either conversion of the wavelength to an electronic signal for electronic switching or special optical add/drop units. The electronic switching has a limited amount bandwidth and this adds constraints on its use. Optical add/drop units add significant insertion loss and affect the need for signal generators.

5.) O-E-O conversion adds latency and jitter to circuits that use them.

6.) O-E-O switching adds even greater amounts of latency and jitter to circuits that use them.

There is a strong need to provide the same kind of automated path determination and dynamic path establishment for optical networks as there are for TCP/IP and ATM networks. This invention provides a method for the first of those needs.

### SUMMARY OF THE INVENTION

The General Invention provides a framework of using multiple hierarchal routing levels to resolve routing constraints and provide path segments that can be used by higher levels to construct paths using those segments as simple links. This allows the higher levels to deal only with those constraints that are applicable to their defined properties. It also groups all the possible alternative paths between 2 points into a small number of “logical links” thus reducing the processing requirements of the route exploration phase and deferring the complex computations for final path commitment to a point where only a small subset of the potential possibilities are being explored.

The specific Invention provides route determination for optical core dense mesh networks that support DWDM over optical fibers at data rates of 2.5 Gigabytes, 10 Gigabytes, 40 Gigabytes, and higher data rates. It supports switching systems that include a mix of electronic and pure optical switching (micro-mirrors, bubbles, or equivalents), discrete data regeneration devices, and discrete lambda translation devices.

The Layer definitions are,

a.) Multiplexor switching that supports mapping STS1, STS3, STS12, and STS48 channels into lambda data streams at STS48, STS192, and STS768 data rates.

b.) OEO switching that provides grooming for channel multiplexing, lambda translation, and data regeneration

c.) Lambda Translation using discrete lambda translation units

d.) Data Regeneration using discrete regeneration units

e.) Lambda switching using micro-mirror and bubble switching units

f.) Whole fiber switching with Optical Add/Drop Multiplexing

### BRIEF DESCRIPTION OF THE DRAWINGS

All of the figures are embedded in the text at appropriate locations. They are for explanatory purposes only and are not meant to convey scale or other physical dimensions. The sole use of the drawings are to provide tutorial assistance for the text descriptions.

### DETAILED DESCRIPTION

The invention is an algorithm that provides optimal paths through a mesh of nodes and links to provide the optimal “simplest shortest path first” that meets the requested routing requirements. The algorithm has a built in model of the mesh and decomposes the mesh into multiple levels to meet the complex routing requirements.

The best embodiment of the invention is a software object that we will call the “GRAPH” that can be integrated into a provisioning system, an automated switching controller, or in a distributed variation embedded in the switching control logic of switches.

A key characteristic of routes that are returned by the Graph object is that it will prefer to return the simplest routes before it returns more complex routes and when alternative routes are of the same simplicity, it will return the shorter of the simplest possible route. The general definition of “simplicity” is the route that can be completed at the lowest possible level in the Graph. This is a somewhat academic answer. Let's use an example from optical networking with DWDM and a diversity of switching methodologies. The lowest level supports whole fiber switching using micro-mirror (or equivalent) switching. Where all lambdas of a fiber are switched as a group. The next lowest level is switching individual lambda(s) using the same.micro-mirror switching. The next higher layer introduces lambda specific signal regeneration (clocking and amplitude) where needed. The next higher level introduces lambda translation only when necessary. The next level introduces O-E-O switching where necessary. The next level above that introduces add/drop multiplexing where necessary. The simplest possible circuit is one that doesn't require signal regeneration, lambda translation, O-E-O switching, or add/drop multiplexing. The next more complex route requires the fewest signal regenerators along its path. The next most complex route requires the fewest lambda translations along its path, ad infinitum.

The simplest route is practically motivated; it is the cheapest route possible. Data regeneration is expensive. At the time this disclosure is written the normal method is to use an O-E-O switch in the path. The invention anticipates discrete single lambda signal regenerators and lambda translators (signal regenerators that can change their output wavelength to whatever is required). These will be cheaper than using O-E-O switching for that function but they will still be more expensive a simple circuit.

The Graph object accomplishes “Simplest Shortest First” by routing in discrete levels, where the lowest (i.e. the simplest level) provides the links used by the higher (i.e. more complex levels). If it is possible to complete a route between A and B at the lowest level, then requests at the higher levels will return a simple path. Multi-hop routes at higher levels will see the simple route between A and B as a single hop and will prefer them to other more complex paths.

Another characteristic of Graph is that it deals with Dense Mesh Networks where there are large numbers of alternative paths between neighbors and many alternative neighbors to choose between for a path that will lead to the destination. The Graph deals with this by using a 2 step approach. Its routing cache contains lists of “approximate paths” that all lead from A to B and are ordered using metrics that support “simplest, shortest, first”. It selects an “approximate path” and “analyzes it” for possible selection. If it meets the selection test, it is then committed, and the exact path chosen is then removed from the set of “approximate paths” in the cache. When the set of “approximate paths” is exhausted or it “ages out”, the cache fill algorithm for the particular level is run to refill it. If it can't find simple paths like it did previously, it will fill itself with more complex paths if that is possible. On the alternative side, if enough simple paths are surrendered and a critical threshold is passed, cache fill is triggered in anticipation of filling with simpler paths Cache fill at higher levels will prefer to fill from lower levels Only when they can't will it fill by running route exploration at its own level.

At the lambda switching level, a cache entry will be a list of fibers and lambda assignments for those fibers that interconnect 2 nodes. We group all the fibers (and their lambdas) that have similar DWDM configurations that terminate in the same pairs of nodes into a single logical link that during route exploration we can treat as a single link. This dramatically reduces the amount of computations required for route exploration (that is where most Dense Mesh routing algorithms fail). We segregate logical links with differing DWDM configurations (differing numbers of channels per fiber or maximum clocking rates per lambda primarily) by fragmenting the cache into multiple entries; one for each DWDM configuration. This allows route exploration to focus on the richness of the inter-connection of neighbors without being swamped with repeated computations for almost identical link traversals.

Higher-level logical links are composed of the cache entries of lower levels. Cache entries of higher levels prefer to use existing cache entries of lower levels where possible. If the lower cache level entry exists and their numbers of “approximate paths” exceed a configuration threshold, path exploration between these nodes will not occur at this level. Only when the lower level cache cannot provide enough “approximate paths” will we have a cache entry that combines both lower level cache entries and routes explored at this level.

We will present a simplified example using both of the above principles. It will show a portion of a hypothetical network at the raw lambda and micro-mirror level and at the lambda translation level. We will for this example ignore the signal regeneration level to keep the example as simple as possible.

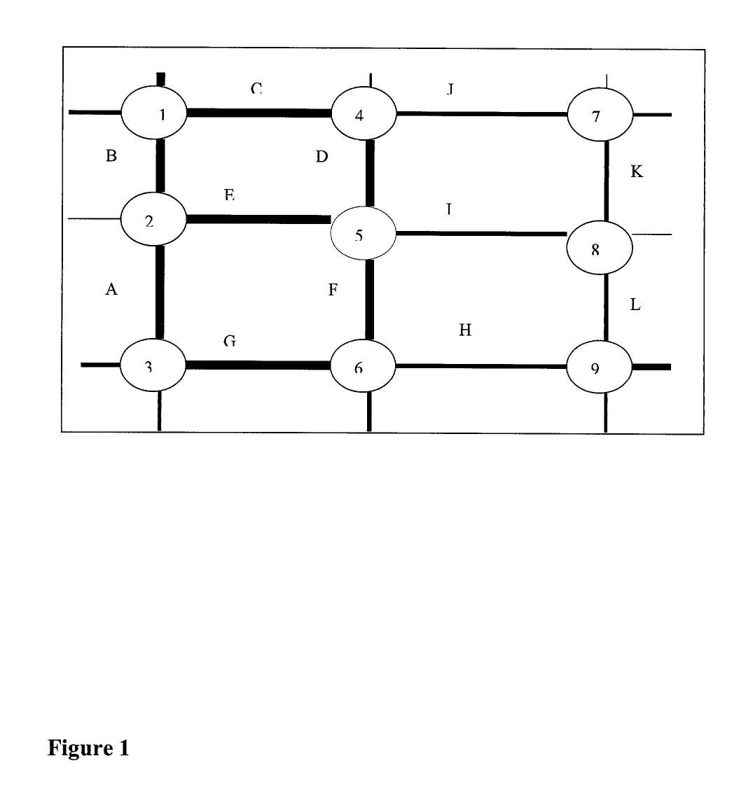

FIG. 1 shows a 3×3 portion of a larger network. Each node is a circle that has a switching or interconnection matrix that switches individual lambdas while preserving their optical integrity (Micro-mirror and bubble switching have these capabilities.). The interconnections represent bundles of DWDM connections that terminate at the same nodes. The thicker lines on the left side represent 128 lambda DWDM configurations and the skinnier lines on the right side represent 96 lambda DWDM configuration. Since each fiber has a multitude of DWDM lambdas the links are “approximate paths”. When we increase the number of fibers a link, we increase the number of “approximate paths” for the link. If a pair of nodes are inter-connected with fibers with multiple DWDM lambda configurations, there will be a link per kind of DWDM lambda configuration. Each link represents the product of the number of lambdas in a DWDM configuration and the number of fibers between the nodes that have that DWDM configuration.

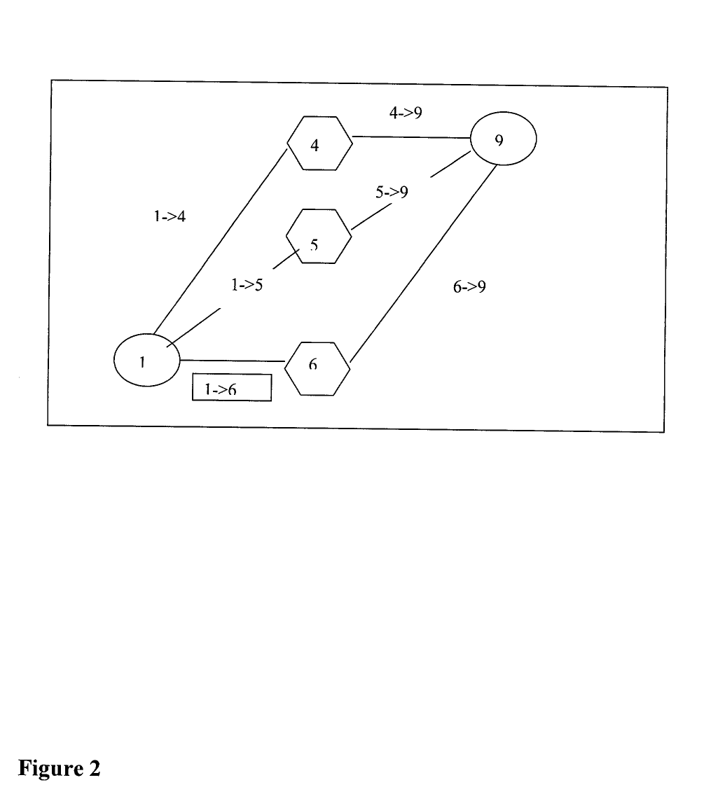

FIG. 2 shows the same region of the network. Note that we have 2 different kinds of nodes in the figure. The larger 6 sided nodes have lambda translators available for assignment to form more complex routes. The circular nodes are source/destination nodes for routes, but do not have (or need for this example) lambda translation capability. The links in this graph are the cache entries of the lower level. For example the link between nodes 1 and 4 in FIG. 2 are all the “approximate paths” that the route explorer discovered while exploring the lower level.

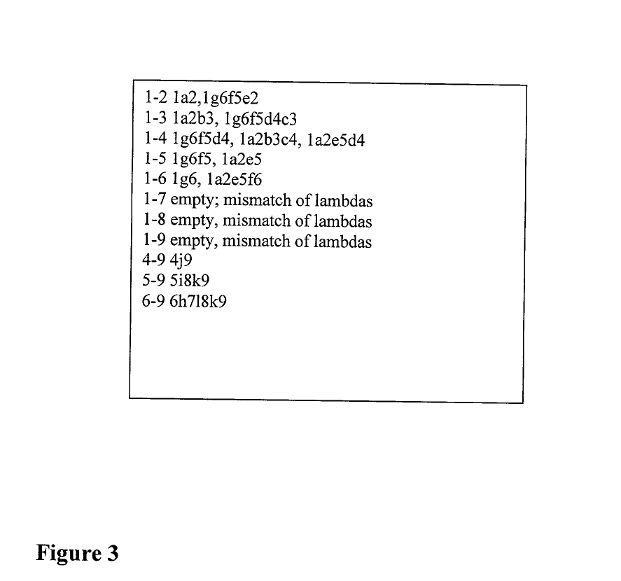

FIG. 3 shows a sampling of the cache entries discovered for the “raw lambda and micro-mirror level of the network”.

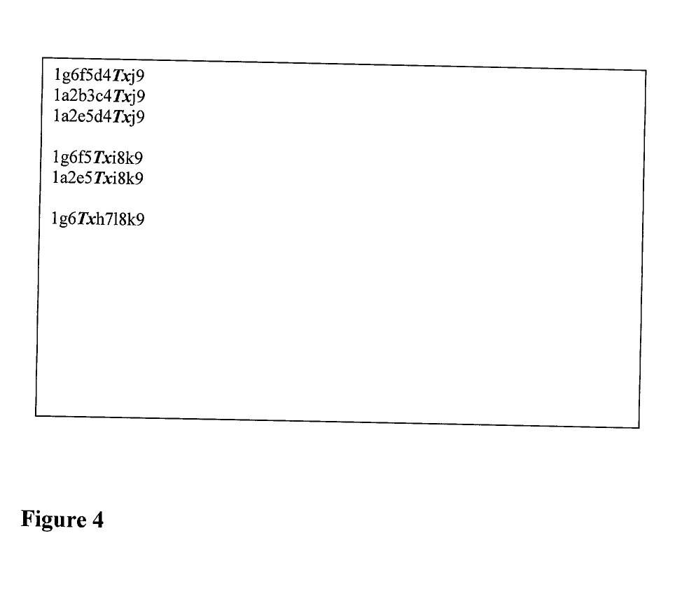

FIG. 4 shows the possibilities that the route explorer discovered between nodes 1 and 9 at the “lambda translation level”. Note the Tx in each possibility. It represents the lambda translator and its placement in the route. The route selection method at the “lambda translation level” selects a route that requires the least number of lambda translators (1 in this case) and for the set of possibilities that are the best, it chooses a subset that requires the fewest signal regenerators, and from that subset, the shortest path in fiber distance. This takes more exhaustive analysis (thus more computation) but it is performed on a small subset of the possible routes in the network. The first 3 routes are the combinations from the 1->4 and 4->9 links. The group of 2 routes are the combinations from the 1->5 and 5->9 links. The last single route is the combination of the 1->6 and the 6->9 links.

There is one constraint that exists at the lower levels of the network that are difficult to grasp at first exposure. Micro-mirrors or bubble switching of a lambda along the path of its route, don't change its optical properties other than introducing some loss of signal strength. That means a path that transits multiple fibers has to be assigned to the same lambda on each of the fibers along the path. But as lambdas are assigned and surrendered, over time there is a possibility that we can reach a situation that an exact path can not be selected from the “approximate paths” because although every link along a “possible path” has available lambdas for assignment, there is not one lambda that is available on all links of every possible path. This condition we will call “lambda assignment blocking”. Similar situations with MPLS labels or ATM's VPI/VCI labels are why label switching is done for each link transition along their paths. In this case, changing a label won't resolve the problem. Only the capability of switching the lambdas a signal is carried over along its path will solve the problem. That is a secondary reason to have “lambda translators”. The invention anticipates this problem by including a metric used in route exploration called “lambda assignment availability”. It summarizes the lambdas available over each link traversed in the exploration and will not continue to explore unless there is at least on lambda assignment shared by all possible links along the paths it is exploring. This creates the property that only paths with available end to end lambda assignments will be entered into the cache at the lowest level in the network. It also establishes the point at which we age out those lower level cache entries. For example, if the path in the “approximate path” set that has the least number of lambda assignments available has 22 of them, then after the 22^{nd} route request after the cache was filled we will age it out. In other words, our cache age out mechanism assumes the worst case; that all 22 of those requests will be successful and will use a lambda assignment from the “approximate path” set that is the most critical.

Route exploration (i.e. cache fill), Route Selection, Approximate path ordering, and cache ageing all depend upon metrics. Each node and link has a set of properties that establish an their contributions to the metrics of paths that traverse them. Fibers are primitive links. They have insertion loss, DWDM characteristics (lambda counts and maximum data transfer rates), and lambda assignment profiles. Each level in the Graph has its own set of metrics that it uses. The metric sets consist of primitive metrics such as insertion loss and lambda assignment availability. The general algorithm defines primitive metrics as classes with the same set of pure virtual methods. The specific algorithm defines primitive metrics that are instance objects of these classes. A metric set used at a specific level, is a metric set class instance with a defined set of primitive metrics and a set of pure virtual methods that are related to those of the primitive metrics.

Route exploration uses 4 pure virtual methods to generalize itself so that it is not dependent upon any specific metric. In this way it is different from Djikstra's algorithm that has a single metric; cost, that is embedded in the algorithm. Graph's route exploration algorithm is a generalization of the maze runner algorithm of first year computer science textbooks. It is modified in that it has isolated the metric from the algorithm and uses metrics as plug-ins to specialize its behavior and that it has a heuristic borrowed from autonomous intelligent agents. This in turn was modeled after the behavior of Bees and Ants. It is called the pheromone metric that is associated with every link in the level of the graph. Each probe in Route exploration will inspect the pheromone metric to see that it can improve on the probes that preceded it. If it can, it continues on after leaving its own pheromone values in the metric. This is the function of the improves and update methods of all metrics. The algorithm also tests its probes against the routing requirements metrics that rule out routes whose aggregate metric values exceed critical thresholds. This is the function of the meets_requirements method of the metrics. The step_over method is used to aggregate metric values along a path.

The pheromone and route requirement heuristics limit the growth of the algorithm to almost linear growth thus making it feasible to use the maze runner.

The invention, as disclosed, uses the same route explorer general algorithm with different metric sets for all levels. A variation of the invention could use different route explorers for each level. It would be possible to use Djikstra's algorithm for example in an additional level built above the highest level we have described and still be within the description of the invention.

The primitive metric types are: Boolean, additive, probability, minimum, set of minimums. Their names identify their aggregation property. An additive metric computes an aggregate property as the sum of the path added with the sum of the component being stepped over. Boolean aggregation is the Boolean AND of the two inputs. Probability deals with values between 0 and 1 and produces the multiplicand of the two inputs. Minimum produces the minimum of the two inputs. Set of minimums produces a new set whose result elements are minimums of their like input elements. All metrics have the property that they are continuous in the range they are used in and that they are monotonically asymptotic from a best value to a worst value. Probability is he easiest to recognize, its best value is 1 and the worst is zero. A value of 0.9999 is worse than 1 and better than 0.9998. A minimum has a best value of infinity and a worst of zero. Boolean has a best of 1 and a worst of 0. Set of minimums has a best of all elements being non-zero and a worst of all elements having zero values. Additive is best at zero and worst at infinity.

Specific metrics used for optical route selection are mapped to one of the 5 types described above. The table below defines the specific primitive optical metrics in column 1, the type it is an instance of in column 2, and its units in column 3.

| Insertion Loss | Additive | Decibels |
|---|---|---|
| Lambda assignment | Sum of Minimums | Lambda indices |
| availability | | |
| Latency | Additive | Milli-second |
| Jitter | Additive | Milli-second |
| Bandwidth availability | Minimum | Bits per Second |
| Bit Error Rate | Probability | Probability |
| Route Length | Additive | Meters |
| Regenerator | Minimum | Integers |
| Availability | | |
| Lambda Translator | Minimum | Integers |
| Availability | | |

Sets of metrics are objects that have an ordered list of primitive metrics, a mapping of those primitives to its improves method, and a mapping of those primitives to its meets_requirements method. The ordering of the primitive metrics is used to establish precedence for a canonical ordering that preserves ‘Simplest Shortest First’ within the scope that the metric set is defined within.

Whole Fiber level

Ordered Primitives—Insertion loss, route length, minimum fiber availability, latency, jitter, bit error rate probability

Improves map—0, 1, 2

Meets requirements map—0,1,2

Path Selection—lambda configuration selection, lambda assignment selection, fiber selection in that order

Lambda level

Ordered Primitives—Insertion loss, lambda assignment availability, route length, bandwidth availability, lambda translator availability, signal regenerator availability, latency, jitter, bit error rate probability

Improves map—0, 1, 2

Meets_requirements map—0,1,2

Path Selection—lambda configuration selection, lambda assignment selection, fiber selection in that order

Note—the primitives after route length are used for precedence, but level 5 adds no significant aggregation contribution to these metrics. Only the first 3 metrics are involved in improves and meets_requirements.

Signal Regenerator level

Ordered Primitives—Lambda assignment availability, route length, bandwidth availability, lambda translator availability, signal regenerator availability, latency, jitter, bit error rate probability

Improves map—0, 4, 1

Meets_requirements map—0, 4, 1

Path Selection—Least signal regenerators, largest lambda assignment availability, shortest route length—Lambda picks best path from selected approximate path

Lambda Translator level

Ordered Primitives—route length, bandwidth availability, lambda translator availability, signal regenerator availability, latency, jitter, bit error rate probability

Improves map—0, 2, 3

Meets_requirements map—0, 2, 3

Path Selection—Least lambda translators, least signal regenerators, shortest route length—Signal regenerator level picks best path from selected approximate path

O-E-O level

Ordered Primitives—route length, bandwidth availability, lambda translator availability, signal regenerator availability, latency, jitter, bit error rate probability

Improves map—0, 1, 2, 3, 4, 5, 6

Meets_requirements map—0, 1, 2, 3, 4, 5, 6

Path Selection—Largest available bandwidth availability, least lambda translators, least signal regenerators, shortest route length—Lambda translator level picks best path from selected approximate path

Multiplexor level

Ordered Primitives—route length, bandwidth availability, lambda translator availability, signal regenerator availability, latency, jitter, bit error rate probability

Improves map—0, 1, 2, 3, 4, 5, 6

Meets_requirements map—0, 1, 2, 3, 4, 5, 6

Path Selection—Largest available bandwidth availability, least lambda translators, least signal regenerators, shortest route length—O-E-O level picks best path from selected approximate path

The graph object has many external interfaces and methods that are used to download the networks mesh definition and changes to it including periodic updates of nodes and links current resource availability. These will not all be described here because there is nothing unique in the invention's implementation of these methods. We will constrain our description to the portions that are unique to the invention, which is its path determination method(s). The best embodiment of the invention is written to be a plug in to provisioning and OSS systems of network service providers. The description of how it interfaces with these systems is not unique and is considered to be more germane to copyright protection than a patent and will not be included in this application. In other words, we will try to limit ourselves to a description of what is unique and advantageous to keep what will be a long complex description from becoming even longer.

The graph object uses objects:

a. Node

b. Node_level

c. Link

d. Link_level

e. Cache

f. Cache_level

g. Primitive_metric_types

h. Metric_sets

i. Path

j. Exact_path

k. Approximate_path

l. Path_request_parameters

m. Path_result_parameters

Graph maintains multiple maps (i.e. neighbor tables). One at each level configured into the graph. The embodiment described uses 5 levels but the graph as implemented can easily be configured to more or fewer levels.

Nodes can be added, deleted, enabled_forwarding, enabled_routing, disabled_forwarding, disabled_routing, Node_update, port_added, port_deleted, port_enabled_forwarding, port_enabled_routing, port_disabled_forwarding, port_enabled_routing, port_updated. Disabling routing allows a port or node to continue forwarding maintaining current connections but allowing no new routes to be established that transit the Disabled component. Based upon the properties of the Node, various node_level objects will be derived from the Node base class and entered into the various data models for the levels that the graph utilizes.

Links can be added, deleted, enabled_forwarding, enabled_routing, disabled_forwarding, disabled_routing, Link_update, lambda_added, lambda_deleted, lambda_enabled_forwarding, lambda_enabled_routing, lambda_disabled_forwarding, lambda_enabled_routing, lambda_updated. Disabling routing allows a lambda or link to continue forwarding maintaining current connections but allowing no new routes to be established that transit the Disabled component. Based upon the properties of the link, various link level objects will be derived from the Link base class and entered into the various data models for the levels that the graph utilizes.

The data structures needed to understand the invention are:

a. A directory of connections that have been established for the network.

b. An inventory of fibers and metallic cables used as links

c. An inventory of transmission equipment used as link/node interfaces

d. An inventory of Interconnection Nodes (primarily switches or patch panels)

e. A structured list of cache objects; each of which have the set of objects that make up a level of the graph

f. A list of lambda configuration structures that are derived from the inventory of transmission equipment

Each cache level has the following components:

a. A map of the interconnections at this level (neighbor list)

b. A cache of paths between pairs of nodes that have common routing characteristics

c. A set of primitive metrics that are used to route paths at this level

d. A cache fill method specific to the level

e. A path commit method specific to the level

f. Set of cache sub-keys

The path commit method uses node and link methods that may optionally command device specific command plug-ins to establish the desired circuits.

The interconnections map is a directory. Each entry has a key that is the identifier of a node that participates at this level in the graph. The values are lists of tuples; a link and a node. The node is the other end of a link that the key node transmits to. This allows the interconnection between 2 nodes by multiple links of varying routing characteristics.

Each cache's path store is a directory that is keyed at the top level with a tuple; the source node and a routing characteristic identifier. The entries are directories whose keys are the destination node identifiers and whose entries are ordered lists of approximate paths.

Each level has a metric set that is specific to the level. Each set is made up of an arbitrary number of primitive metrics; each of which is one of 5 basic types. Each set has an ordering precedence among its primitive metrics so that comparing 2 instances of the sets will establish either an equality or precedence ordering. Each primitive metric has the following methods: step_over( ), meets_requirements( ), improves( ), update( ), is_equal( ), better( ).

We claim:

1.) A route determination algorithm with the properties that it routes on multiple levels concurrently using varying related route requirements, paths from lower levels act as simple links at higher levels, and returns a selection of routes of varying characteristics that all meet the route requirements for final route commitment.

2.) The method of claim 1, wherein each level has the following level specific data sets:
a. A set of nodes
b. A set of links that interconnect the nodes
c. An array describing the interconnection of links and nodes
d. A level is either full duplex or half duplex
e. A set of metric properties used at this level
f. A cache fill algorithm used to fill the array of cache entries for this level
g. A resource reservation, selection, and commitment method
h. A cache of previously discovered approximate paths that have not yet been aged out.

3.) The method of claim 2a, wherein each node/link has a set of primitive metric values that are used to calculate a path's aggregate values (by its cache fill algorithm (claim 2.f)). The members of the set are different for each level (claim 30). When a common cache fill algorithm is used (claim 59), the step_over method will perform the aggregation (claim 32).

4.) The method of claim 2a, wherein each node/link has a set of resources that are used to interconnect the links to provide a data transmission path of multiple hops (i.e. using multiple cascaded fibers or wavelengths).

5.) The method of claim 2a, wherein the resources a node has determines whether it has a basic property that is used to determine the node's participation at a level. Example, if the level is Lambda switching level, then the node must have Lambda ports (and Lambda switching matrix by implication) to participate.

6.) The method of claim 5, wherein a node has a set of ports that serve as input or output for a data stream, the port has a line speed that is an operational characteristic, and it has the ability to connect any of its input ports to any output port to extend a data transmission path.

7.) The method of claim 2a, wherein a node may have properties that allow it to participate at multiple levels and its participation at one level is not conditioned on its participation at any other level.

8.) The method of claim 2b, wherein at the lowest operational level of the algorithm a link is either:
a. A set of single fibers that all have the same node terminations and can transmit data in the same direction.
b. A set of pairs of fibers that all have the same node terminations and can transmit data in both directions using one fiber in one direction and the other fiber in the reverse direction

9) The method of claim 2b, wherein each link has a set of resources that are used to carry multiple data streams from its transmission ports to its receiving ports.

10.) The method of claim 2b, wherein at levels above the lowest level, a link is a cache entry at the next lower level; possibly cascading to the lowest level.

11.) The method of claim 2b, wherein each link has a set of primitive metric values that are used to calculate a path's aggregate values by the cache fill algorithm. The makeup of the set is defined by the level (claim 30). When a common cache fill algorithm is used (claim 59), the step_over method will perform the aggregation (claim 32).

12) The method of claim 11, wherein when a link is actually a set of cache entries from a lower level, it inherits the cache entries path aggregate metrics (with level dependent translation) as its link metrics.

13) The method of claim 2b, wherein during cache fill (claim 2f), a link has a set of pheromone aggregate metrics that are initialized at worst case values so that the first path probe of a non-transited link will always pass the improves condition (claim 36), update the value (claim 36) and succeeding possible transits will only work if they can improve the value further.

14) The method of claim 2b, wherein for half duplex links, all transmission ports are components of the same node and all receive ports are components of the same node.

15) The method of claim 2c, wherein the neighbor array has an entry for each node at this level, each cell contains a list of pairs.

16) The method of claim 15, wherein each pair is the pointer to a link and a pointer to a node (that is the other end of the link (i.e. A neighbor node)).

17) The method of claim 15, wherein for full duplex links, the neighbor node will have a companion entry including the same link and itself.

18) The method of claim 15, wherein this structure allows as many links between the same pair of nodes as there are unique links with differing routing characteristics (including DWDM transmission characteristics).

19) The method of claim 15, wherein for half duplex nodes, the direction of travel is embedded in the neighbor structure. If the travel is from node A to node B using link 6, Then in the neighbor array, node A will have an entry [6,B] but node B will not have a corresponding entry [6,A]. If there is a path from Node B to Node A it will use a different link whose direction is B to A.

20) The method of claim 2d, wherein for each level, two independent caches are maintained; one for full duplex path requests, the other for half duplex path requests

21) The method of claim 2h, wherein each cache may have sub-caches for route differentiation to preserve routing properties. For example Source A may have multiple links fanning out from it to neighbor nodes, each has a different set of DWDM lambda characteristics. We explore each of these in a single cache fill pass but we keep the results in different cache entries keyed off the DWDM lambda configuration characteristics (i.e. 128 channels by 1 Gigabit)

22) The method of claim 2h, wherein the cache structure is a directory of directories. The upper directory key is (Source node index, sub-cache key) and the lower directory key is the destination node identifier

23) The method of claim 22, wherein each destination level cache entry also contains a age property of when the cache was filled.

24) The method of claim 23, wherein the age property is the current path index value (claim 70) at the global level of the algorithm of the route request that causes the cache to be filled.

25) The method of claim 24, wherein a cache entry's age is the difference between the current path index and the one recorded in claim 23.

26) The method of claim 2g, wherein each cache level has a get_path method that returns a set of possible paths from the source to the destination that meets the routing requirements.

27) The method of claim 26, wherein each level's get_path method checks to see if the cache is empty or aged out and if it has, it attempts to get a cache from its next lower level and only if that fails will it fill its cache from that lower level and build an entry for the destination node and then attempt to fill the path request from that cache's entries.

28) The method of claim 27, wherein each level's get_path method passes its results to the global get_path function which converts the relative path at that level to the fully filled in final path by using the top level's commit method (claim 29).

29) The method of claim 2g, wherein each cache level has a commit method that reserves resources for its level components (links or nodes) and then commits the lower level portions of its path. If that is successful it then commits the reserved resources and returns the final path fragment to its caller. If the lower levels are unsuccessful for any reason it returns a failure to the top level that can then choose a different path from the set it was given.

30) The method of claim 2e, wherein a metric set for a level is made up of a set of primitive metrics that have a set of methods that are common to all. Each metric set shares the same set of methods. Application of one of these methods for the set generally applies the method to all the primitives that are within the set (the improves method is an exception). The set of primitives used at any level is independent of those used at other levels. A primitive metric may or may not be used in multiple levels.

31) The method of claim 30, wherein the common methods are step_over, meets_requirements, improves, update, is_equal, better, copy, get_value.

32) The method of claim 31, wherein “step_over” accepts a path aggregate metric (or metric set) and a node or link specific metric (or metric set) and produces a new path aggregate metric set that represents the path values when the path is extended over the node or link being considered.

33) The method of claim 31, wherein “meets_requirements” accepts a path aggregate metric (or metric set) and a route requirements aggregate metric (or metric set) and returns a Boolean value whether the path does or does not meet the route requirements.

34) The method of claim 31, wherein “improves” accepts a path aggregate metric (or metric set) and a pheromone aggregate metric (or metric set) and returns a Boolean value whether the path can improve on one or more critical primitive metrics that apply to this level of the algorithm.

35) The method of claim 31, wherein “update” accepts a path aggregate metric (or metric set) that will improve upon a pheromone aggregate metric and the pheromone aggregate metric (or metric set) and records the improved values in the pheromone aggregate primitive metrics that will be improved.

36) The method of claim 30, wherein general primitive metrics are one of the following types:
a) Boolean
b) minimums
c) additive
d) probability
e) sets of minimums

37) The method of claim 36, wherein a subset of the primitives of a set participate in the “improves” method of the set.

38) The method of claim 36a, wherein “step-over” a Boolean produces an AND of the two input values

39) The method of claim 36a, wherein “meets-requirements” of a Boolean is the AND of the two input values

40) The method of claim 36a, wherein “improves” of a Boolean is true if the path aggregate is true and the pheromone value is False

41) The method of claim 36a, wherein “update” of a Boolean substitutes True for a pheromone's value if the path aggregate is True and the pheromone value is False

42) The method of claim 36b, wherein “step_over” a minimum produces a minimum of the two input values

43) The method of claim 36b, wherein “meets_requirements” of a minimum returns True if the path aggregate is larger than or equal to the requirements aggregate.

44) The method of claim 36b, wherein “improves” of a minimum returns True if the path aggregate is larger than the pheromone aggregate and False otherwise.

45) The method of claim 36b, wherein “update” of a minimum replaces the pheromone value with the path value IF the path value improves the pheromone value

46) The method of claim 36c, wherein “step_over” an additive produces a sum of the two input values

47) The method of claim 36c, wherein “meets_requirements” of an additive returns True if the requirement aggregate is equal to or larger than the path aggregate.

48) The method of claim 36c, wherein “improves” of an additive returns True if the path aggregate is less than the pheromone aggregate and False otherwise.

49) The method of claim 36c, wherein “update” of an additive replaces the pheromone value with the path value IF the path value improves the pheromone value

50) The method of claim 36d, wherein “step_over” a probability produces a multiplication of the two input values

51) The method of claim 36d, wherein “meets requirements” of a probability returns True if the requirement aggregate is less than or equal the path aggregate.

52) The method of claim 36d, wherein “improves” of a probability returns True if the path aggregate is larger than the pheromone aggregate and False otherwise.

53) The method of claim 36d, wherein “update” of a probability replaces the pheromone value with the path value IF the path value improves the pheromone value

54) The method of claim 36e, wherein “step_over” a set of minimums produces a set of minimums of which each indices value of the output is the minimum of the corresponding indices of the input values. To be clear, if a[3] is 4 and b[3] is 6, then result[3] will be 4.

55) The method of claim 36e, wherein “meets_requirements” of a set of minimums returns True if any indices value of the path aggregate is greater than or equal to the requirements aggregates corresponding indices value.

56) The method of claim 36e, wherein “improves” of a set of minimums returns True if any pheromone aggregate's indices value is zero and its corresponding path aggregate's indices value is greater than zero.

57) The method of claim 36e, wherein “update” of a set of minimums replaces the pheromone indices value with the corresponding path indices value if the path value is greater than the pheromone value.

58) The method of claim 2f, wherein each level may have a custom cache fill algorithm or it may use a common one that depends upon the level specific metrics to customize its behavior.

59) The method of claim 58, wherein the common cache fill algorithm uses the “step_over”,“meets_requirements”, “improves”, and “update” methods (claim 31) to guide the level specific cache filling.

60) The method of claim 2f, wherein the cache fill algorithm starts from the source and explores all one hop paths to neighbors, followed by 2 hop paths, then 3 hop paths, . . . , until there are no more paths to explore. This is the classical maze runner algorithm that can be found in many computer science text books.

61) The method of claim 60, wherein each iteration of the algorithm works off of a ring structure developed as an output by the preceding iteration and produces a ring structure to be used as input for the next iteration.

62) The method of claim 61, wherein the ring is a directory of value and path combinations for the next intermediate node in an outward probe. The key to the directory is the index of the node at this level.

63) The method of claim 62, wherein each intermediate node iteratively examines its neighbors for possible extensions to its set of partial paths

64) The method of claim 63, wherein each time the algorithm “steps over” a link and next node successfully, it writes all the paths that it is carrying with it to the cache.

65) The method of claim 64, wherein a path does not output to the output ring when:
a) The intermediate node or link is disabled
b) The link lambda parameters do not match the paths lambda parameter
c) The path already contains the link or node
d) The intermediate path exceeds any route requirement metric
e) The intermediate path encounter a link that has already been transited and it can't improve upon the link's pheromone value

66) The method of claim 65e, wherein each successive transit of a link must improve upon one of several primitive pheromone values left by previous transits. These are defined in claim 2d.

67) The method of claim 2g, wherein each level of the commits method (reserve, select, and commit method) cascades down to commit lower level components before it returns a committed path to its upper levels.

68) The method of claim 67, wherein when higher level paths find that a full path that it is trying to commit cant be completed, it has to release the committed or reserved lower level segments of the path before examining the next possibility (claim 29).

69) The method of claim 1, wherein each level is associated with specific routing properties and all paths in the level's cache (claim 2d) will possess that routing property and all links and nodes participating in the level will preserve the property. For example, at the Lambda routing level, a path from end to end will use the same DWDM wavelength and be bounded by the specific portion of the light spectrum that is that wavelength. All nodes and links along the path will preserve this property.

70) The method of claim 1, wherein the algorithm maintains a global index that is incremented for each path request at any level. This is used to record when cache entries are filled and to age them out.

71) The method of claim 1, wherein the algorithm has a “find_route” method that accepts a number of parameters such as source, destination, routing requirements, and initial aggregate values and returns either an acceptable route or a failure indicator.

72) The method of claim 71, wherein the initial aggregate values are provided so that routes from multiple administrative domains may be stitched together into a single path that intermediate Path Determination Algorithms can determine the acceptability of paths they are considering.

73) The method of claim 71, wherein the routing parameters instantiation sets the find_route method to call the highest level of its cache's get_path method and then calls its select_path method to commit a path from the current cache entries.

74) The method of claim 71, wherein the algorithm maintains a set of lambda configurations that includes all configurations seen at any link in its data sets for the Lambda and data regeneration levels. This is used to help it decide lambda configuration suitability for paths.

75) Claim 1 is not in any way sensitive to any data framing format for the data streams that traverse its routes, nor is it dependent upon any specific formats for exchange of data about the information in its data structures, nor is it specific to any methods of commanding switching and transmission gear to create route segments. The invention is opaque to the contents or the framing/modulation structure of the data that flows along the path it establishes.

76) An implementation of claim 1 that is specific to the problem of routing in an optical network. It introduces an assignment of levels to specific optical routing properties, node and link resources that have these properties, metrics that allow route requirements based upon these properties, and path selection algorithms that optimize the use of network resources to deliver these properties. This is accomplished using the general cache_level_base and the level specific cache_level instances.

77) The method of claim 76, wherein the levels are from top to bottom:
a) Multiplexor level that supports add and dropping sub-channels of varying sizes at particular switch ports in the network.
b) O-E-O switching level that supports switching of optical routes using bandwidth limited electronic switching technologies such as TDM
c) lambda translation level that supports discrete or built in transitions from one lambda to another through non TDM techniques such as VCSEL units
d) lambda signal regeneration that does not require lambda translation or TDM switching
e) Lambda level routing of lambdas
f.) Whole Fiber level routing including all lambda within a fiber

78) The method of claim 76, wherein the cache for the lambda signal regeneration and Lambda levels use sub-caching (claim 26) for paths of differing lambda configurations. For example, one sub-cache may contain paths for 128 channels at 2.5 gigabits per channel while another may have paths for 96 channels at 10 gigabits per channel.

79) The method of claim 78, wherein the primitive metrics are:
a) Route Length (additive type-claim 36c) is the length of a fiber or path in meters.
b) Insertion loss (additive type-claim 36c) is the decibel of signal loss of a fiber, switch traversal or a path
c) Regenerator availability (minimum type-claim 36b) is the number of signal regenerators available at a node along a path that has the least of all nodes in the path; for a node it is the number of signal generators that the node has available for assignment.
d) Lambda translator availability(minimum type-claim 36b) is the number of lambda translators available at a node along a path that has the least of all nodes in the path; for a node it is the number of lambda translators that it has available for assignment.
e) Lambda assignment availability (set of minimums-claim 36e) is the minimum number of assignments available for each lambda at any link along a path.
f) Latency (additive-claim 36c) is the estimated delay a signal will experience transiting a path in milliseconds.
g) Jitter (additive-claim 36c) is the estimated variance in delay a signal will experience transiting a path in milliseconds.
h) Bandwidth availability (minimum-claim 36b) is the minimum bandwidth availability at any link or node that a path transits
i) Bit Error rate probability (probability-claim 36d) is the probability that a signal that transits the path will see no bit errors in any standard time period.

80) The method of claim 76, wherein at the lambda switching level a link is a bundle of single fibers or pairs of fibers, each with its own insertion loss that may vary even when all fibers in the bundle are the same length. We estimate the nominal insertion loss as the mean between the fibers with remaining lambda assignments that are the maximum and minimum for the bundle (specialization of claim 12).

81) The method of claim 76, wherein Lambda level metric set (Specialization of claim 30) has insertion loss, lambda assignment availability, lambda translator availability, regenerator availability, route length, available bandwidth, latency, jitter, and bit error rate probability. Improves only looks at Insertion loss, lambda assignment availability, and route length.

82) The method of claim 76, wherein Regenerator level metric set (Specialization of claim 30) has lambda assignment availability, lambda translator availability, regenerator availability, route length, available bandwidth, latency, jitter, and bit error rate probability. Improves only looks at lambda assignment availability, regenerator availability, and route length.

83) The method of claim 76, wherein Lambda Translator level metric set (Specialization of claim 30) has insertion loss, lambda assignment availability, lambda translator availability, regenerator availability, route length, available bandwidth, latency, jitter, and bit error rate probability. Improves only looks at lambda translator availability, regenerator availability, and route length.

84) The method of claim 76, wherein O-E-O level metric set (Specialization of claim 30) has lambda translator availability, regenerator availability, route length, available bandwidth, latency, jitter, and bit error rate probability. Improves only looks at Lambda translator availability, regenerator availability, available bandwidth, and route length.

85) The method of claim 76, wherein Multiplexor level metric set (Specialization of claim 30) has lambda translator availability, regenerator availability, route length, available bandwidth, latency, jitter, and bit error rate probability. Improves only looks at Lambda translator availability, regenerator availability, available bandwidth, and route length.

86) The method of claim 76, wherein cache age out for Lambda level is when cache age (Specialization of claim 25) is greater than the total of minimum lambda assignments available for the minimum path when recorded.

87) The method of claim 76, wherein cache age out for regenerator level is when cache age (Specialization of claim 25) is greater than the minimum regenerators available for the minimum path when recorded.

88) The method of claim 76, wherein cache age out for lambda translator level is when cache age (Specialization of claim 25) is greater than the minimum lambda translators available for the minimum path when recorded.

89) The method of claim 76, wherein cache age out for O-E-O level is when cache age (Specialization of claim 25) is greater than the minimum available estimated connections (a function of minimum available bandwidth) for the minimum path when recorded.

90) The method of claim 76, wherein cache age out for multiplexor level is when cache age (Specialization of claim 25) is greater than the minimum available sub channels (a function of minimum available bandwidth) for the minimum path when recorded.

91) The method of claim 76, wherein regenerator level path selection is a 4 step selection of (Specialization of 2g):
a) order paths on fewest required generators, best lambda configuration, best lambda availability
b) pick and reserve generators at nodes
c) pick and reserve lambda assignment
d) iterate over Lambda level fiber selection with lambda assignment as input until all links have fiber assignments.
e) commit fiber assignments, lambda assignment, lambda configuration, and regenerators

92) The method of claim 91d, wherein Lambda level fiber selection is an 5 step selection of (Specialization of 2g):
a) For the chosen lambda calculate the minimum possible end to end insertion loss by aggregating the minimum nominal insertion loss from the fibers in each link which have that lambda available.
b) calculate a target insertion loss of min_loss+(½*(max_loss−min_loss)) where max_loss is the insertion loss from the routing requirement metric set for the path selection.
c) assign a random order to the links of the path
d) iterate through all combinations of fibers using the random ordering; recording the closest to the target until a match to the target is found
e) if no match is found return the closest fit

93) The method of claim 91a, wherein Lambda configuration selection is a multi-step task:
a) order the configurations in descending order of transmission speed followed by channel count
b) iterate from the bottom; ignoring all transmission speeds less than routing requirements
c) exhaust all possibilities of a path at a configuration before moving to the next
d) if transmission speed is greater than the routing requirements check if the local policy table allows this combination

94) The method of claim 91 c, wherein Lambda assignment selection is a multi-step task:
a) precedence order the paths; largest number of non-zero lambda assignments, deepest single lambda assignment, largest count with the maximum depth, lowest lambda index with the maximum depth.

95) The method of claim 76, wherein lambda translator level path selection is a multi step task (Specialization of 2g):
a) order paths on fewest required translators, fewest required generators, best lambda configuration, best lambda availability, shortest route length
b) pick and reserve lambda translators at each node
c) find and commit generator level links
d) commit lambda translators

96) The method of claim 76, wherein O-E-O level path selection is a multi step task (Specialization of 2g):
a) order paths on fewest required translators, fewest required generators, largest available bandwidth, shortest route length, best bit error rate possibility
b) reserve the required bandwidth at each node
d) commit lambda translator level links
e) commit the bandwidth for the nodes

97) The method of claim 76, wherein Multiplexor level path selection is a multi step task (Specialization of 2g):
a) order paths on fewest required translators, fewest required generators, largest available bandwidth, shortest route length, best bit error rate possibility
b) reserve the required bandwidth at each node
d) commit O-E-O level links
e) commit the bandwidth at the nodes

98) The method of claim 76, wherein the entries in each levels neighbor array for the Lambda level and the regenerator level allows as many links between a pair of nodes as there are unique lambda configurations installed on fibers that connect the pair (specialization of claim 67).

99) The method of claim 76, wherein ports terminates level specific properties (specialization of claim 6). Whole fiber ports source/terminate all the lambdas of a fiber collectively at the fiber switching level of the algorithm using the fiber-switching matrix. OADM ports source/terminate a subset of the lambdas of a fiber collectively at the fiber switching level of the algorithm. Lambda ports source and terminate individual lambdas and maintain lambda data integrity along the path using the OEO and/or lambda switching matrix plus regenerators and/or lambda translators. Multiplexor Ports match sub-lambda standard optical multiplexor channels to a lambda using the OEO switching matrix.

100) The method of claim 76, wherein as links inherit characteristics from the cache entries at the next lower level, the metrics of the lower levels are translated into metrics at the higher levels (specialization of claim 12).

101) The method of claim 100, wherein For the generator level we drop use of the insertion loss primitive metric. All other values translate as is. Routing requirements metric set will trigger termination of path search when the aggregated insertion loss exceeds its value (the maximum allowable insertion loss). This will preserve that no path will allow signal level to drop below the level where it is so degraded as to be unusable.

102) The method of claim 76, wherein Nodes that participate in LAMBDA routing level have switching matrices that maintain a lambdas spectrum properties as they transit the matrix such that a receiver terminating a multi-hop path will not be able to determine whether the transmission was from a direct neighbor or not. The only allowable deviation from this condition is that the signal strength may be degraded more than it would if it were traversing a fiber of length greater than the path across the switching matrix, but the degradation may not be sufficient to significantly impede the receivers ability to discern the data transmitted over the path (Specialization of claim 3).

103) The method of claim 102, wherein Nodes that participate in the regeneration level will also maintain a lambdas spectrum properties. The nodes have a property that they will provide signal regeneration to compensate for any aggregated signal distortion that may have occurred in the path prior to the node. Thus paths at this level or above do not need to be concerned with insertion loss, since the level below will insure insertion of regenerators when appropriate.

104) The method of claim 103, wherein Nodes that participate in the lambda translation level will be able to match output ports that use one lambda with input ports that use a different lambda while preserving the data integrity of the data stream using the lambdas as transmission media. There are 2 mechanisms to insure this. The first is the lambda_assignment_availability metric. When there is no available lambda assignments, a new segment will be terminated with a lambda translator. The second is a test in the cache fill algorithm that insures that a path will only extend along links that have the same lambda configuration as that of the source link.

105) The method of claim 104, wherein Nodes that participate in the O-E-O level will preserve the data integrity of the data streams that traverse them.

106) The method of claim 105, wherein Nodes that participate in the Multiplexor level will provide add/drop multiplexing capability while preserving the integrity of the aggregate data streams that transit the node.

107) The method of claim 31, wherein is_equal accepts two metrics and produces a boolean ‘1’ if they are or a boolean ‘0’ if not.

108) The method of claim 31, wherein better accepts a path aggregate metric (or metric set) and a second metric (or metric set) and produces a boolean ‘1’ if the second is better than the first.

109) The method of claim 31, wherein copy accepts an aggregate metric (or metric set) and creates a new metric that is a copy of the first.

110.) The method of claim 31, wherein get_value of a primitive metric return its current value.

111.) The method of claim 36, wherein a subset of the primitives of a set participate in the meets_requirement method of the set.

112) The method of claim 76, wherein Whole fiber level metric set (Specialization of claim 30) has insertion_loss, route_length, available bandwidth, lambda translator availability, regenerator availability, route length, latency, jitter, and bit error rate probability. Improves only looks at insertion_loss and route length.

113) The method of claim 76, wherein cache age out for whole fiber level is when cache age (Specialization of claim 25) is greater than the maximum of the minimum fiber count for each path in the cache.
